(19) United States
(12) Patent Application Publication
(10) Pub. No.: US 2006/0034582 A1
(43) Pub. Date: Feb. 16, 2006

(54) METHOD FOR SCREEN SNAPSHOT

(76) Inventor: Chih-Wei Hu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,562

(22) Filed: Jun. 29, 2005

(30) Foreign Application Priority Data
Aug. 12, 2004 (TW) 093124286

(51) Int. Cl. H04N 5/76; H04N 5/225

(52) U.S. Cl. 386/46; 386/117

(57) ABSTRACT

A method for screen snapshot connects a tuner to a video signal source for receiving a wanted channel signal. The analogical signal from the tuner is transformed into a digital signal via an analog/digital converter. By pushing a snapping button, the digital signal processor starts to capture the wanted image signal, and saves the signal in a buffer memory. Then, the digital signal processor orderly reads out that signal from the buffer, and processes them into a JPEG file to store in a storage for sharing the information. Thus, the process of snapping operation can be simplified so as to immediately capture the image.

### BACKGROUND OF THE INVENTION

1. Field of the Invention

The invention relates to a method for screen snapshot, and more particularly to a method for quickly capturing a real time video signal on a screen.

2. Description of the Prior Art

Due to the prompt development of internet and communication, the tendency which consumers enjoy instantly sharing favorite video with others steps up. Therefore, for sharing a real time image on a screen, as shown in FIG. 1, a conventional computer 10 is currently used to snapshot and process the video signal. The video signal received by a TV box 11 is transmitted to the computer 10 through a USB connector and a USB interface 12, and the image can be displayed on a computer screen 17. When the image needed to be snapshotted is seen on the screen 17, users immediately start snapshotting the image if the computer 10 has installed a image snapshot device 13, such as a image snapshot card, and relevant software. The image snapshot device 13 will be based on a predetermined snapshotting speed to capture the transmitting video signals of one or more sheets of the image, and saves in a buffer memory 14. Then, a center processor unit 15 of the computer 10 implements operations of format-transforming and compression of video signals which are temporarily stored in the buffer memory 14, and outputs them in a storage 16 for use as one's please.

There are many differences in input/output interface between the computer 10 and TV box 11, such as coaxial cable, AV connector, IDE, USB1.0, USB 1.1, USB 2.0, and IEEE 1394. Therefore, the interface transform and connection become very difficult and boring. In addition, each device needs some wires for supplying power individually and connecting with other devices, not only causing wire connecting complexity and overload, but also causing wires in a tangle to increase the difficulty of assembly and disassembly.

Even though the connection has been set up, there still needs the TV box 11 to search favorite channels through an antenna or cable TV and transform analogical video signals into digital video signals. There also needs a USB interface with high transmission rate to deliver digital video signals in time to the computer 10. The computer 10 must be equipped with the compliable image snapshot device 13 and operation software, too. Thus, when giving a command, the computer 10 then can start operation software to snapshot wanted images by use of the image snapshot device 13 and save them in a buffer memory 14. However, the installation of the image snapshot device 13 and operation software is very complicated, and snapshotting operation is complex. They usually make users frustrated. Meanwhile, the restrictions of the processing speed of the computer, the response of the snapshot device, and the transmission rate cause the snapshot speed not to immediately snapshot wanted image on the screen. Besides, it's not convenient to use the snapshotting operation with a computer due to the restriction of movement and carry of a computer.

### SUMMARY OF THE INVENTION

It is an object of the invention to provide a method for screen snapshot capable of simplifying the operation procedure of image snapshotting for capturing the wanted image on the screen in time.

It is another object of the invention to provide a method for screen snapshot suitable for snapshotting the wanted image on the screen in any situation capable of receiving video signals.

It is further another object of the invention to provide a method for snapshotting the image on the screen without a computer to avoid the perplexity of connection and software operation for using conveniently.

For achieving the above objects, the invention connects a tuner to a video signal source for receiving a wanted channel signal. The analogical signal from the tuner is transformed into a digital signal via an analog/digital converter. By pushing a snapping button, the digital signal processor starts to capture the wanted image signal, and saves that signal in a buffer memory. Then, the digital signal processor orderly reads out those signals from the buffer memory, and processes them into a JPEG file to store in a storage for sharing the information. Thus, the process of snapping operation can be simplified so as to immediately capture the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

Other objects, features, and advantages of the invention will become apparent from the following detailed description of the preferred but non-limiting embodiments. The following description is made with reference to the accompanying drawings. Anyone who is skilled in related technology would be able to understand and implement the technology accordingly.

FIG. 1 (Prior Art) is a flow chart of snapshoting the image on a screen according to a conventional computer;

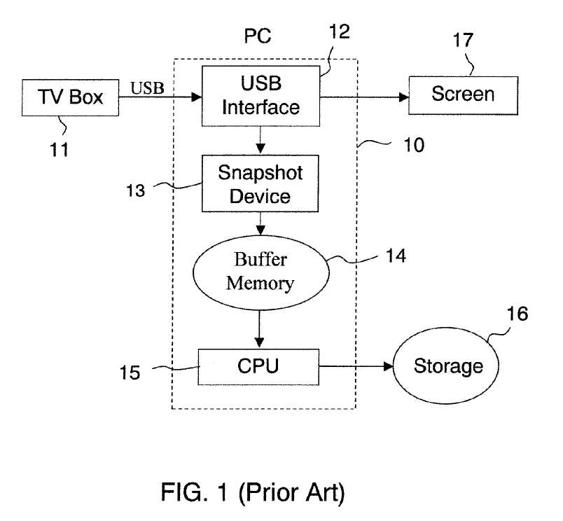

FIG. 2 is a flow chart of snapshoting the image on a screen according to the invention;

### DETAILED DESCRIPTION

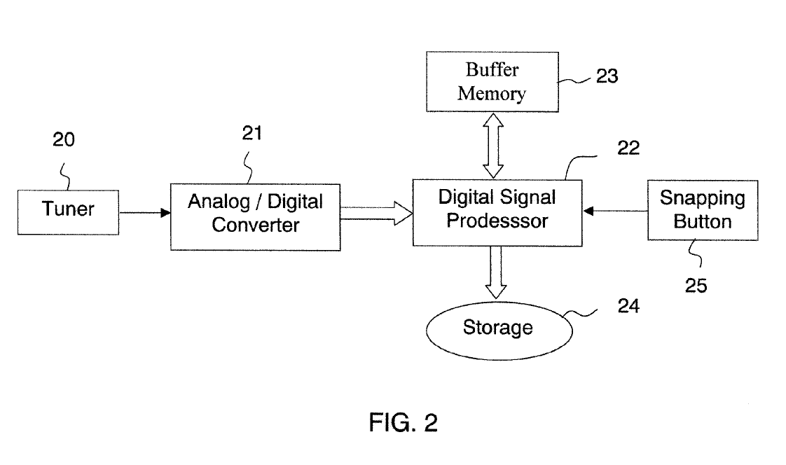

Referring to FIG. 2, a method of screen snapshot according to an embodiment of the invention is shown. The method includes a tuner 20, an analog/digital converter 21, a digital signal processor 22, a buffer memory 23, a storage 24, and a snapping button 25. By pushing the snapping button 25, the digital signal processor 22 starts to snapshot a wanted image on a screen.

The tuner 20 is connected to an antenna or a cable TV for selecting favorite channels and receiving analogical video signals. The video signal received by the tuner 20 is transmitted to the analog/digital converter 21, and is transformed into a digital video signal by the analog/digital converter 21. Then, the digital video signal is delivered to the digital signal processor 22. After processing, the digital signal processor 22 sends the digital video signal to the buffer memory 23, and temporarily saves it therein. The buffer memory 23 has a proper memory capacity, which can be predetermined according to a request, to memorize one or more sheets of image video signal. The digital signal processor 22 can read out the digital video signal from the buffer memory 23 in order, and transforms it into a static compression image format, such as JPEG. The static image format is finally transmitted to the storage 24 and is saved therein for use as one's please. The storage 24 can be an external or built-in memory, such as a memory card or a flash disk, which is portable memory device. Furthermore, the snapping button 25 is disposed to start the digital signal processor 22 beginning to snapshot the video signal.

In order to snapshot the real time image quickly, the invention first connects the tuner 20 to a video signal source so as to receive video signals from a wanted channel, and transmits the video signal to the analog/digital converter 21. The analog/digital converter 21 transforms the video signal, which is an analogical signal from the tuner 20, into a digital signal. By pushing the snapping button 25 to starts up the digital signal processor 22, the digital signal processor 22 instantly captures the wanted image video signal, and delivers it to the buffer memory 23 to temporarily save therein. Then, the digital signal processor 22 will read out the video signal from the buffer memory 23 in order, and transform it into a static image format. Finally, the static image format is saved in the storage 24 for the use of sharing information.

The invention can be formed as a single module with the analog/digital converter 21, the digital signal processor 22, the buffer memory 23, the storage 24, and the snapping button 25. The single module can be constructed as an independent device capable of directly connecting a video signal source, or disposed in a relevant system which needs to snapshot an image. If necessary, the module can also add the tuner 20 for extending the scope of use. Therefore, without a computer, the invention is able to snapshot a real time image on the screen by just pushing the snapping button 25, and avoids tortures of wire connection and a wire tangle of assembly and disassembly. Not only the invention is suitable for any video signal source without a computer, but it can increase the convenience by simply inserting.

Besides, by pushing the snapping button 25, the invention can quickly start the digital signal processor 22 to immediately snapshot a wanted image. The installation of the image snapshot card and relevant software and the complicated operating procedure of screen snapshot can also be escaped. The invention reduces the difficulty of screen snapshot, and raises the efficiency to fulfill consumer's requirements of instantly sharing image information.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for screen snapshot comprising the steps of:
transforming an analogical video signal into a digital video signal with an analog/digital converter;
pushing a snapping button to start a digital signal processor;
snapshotting the digital video signal from the analog/digital converter with the digital signal processor;
storing the digital video signal snapshotted by the digital signal processor in a buffer memory;
reading out the digital video signal from the buffer memory, and transforming it into a image format with the digital signal processor; and
saving the image format in a storage.

2. The method for screen snapshot of claim 1, further comprising a step of receiving and selecting the analogical video signal from a signal source with a tuner.

3. The method for screen snapshot of claim 1, wherein the digital video signal snapshotted by the digital signal processor is temporarily stored in the buffer memory.

4. The method for screen snapshot of claim 1, wherein the image format is a static compression image format.

5. The method for screen snapshot of claim 1, wherein the image format is a JPEG format.

6. The method for screen snapshot of claim 1, wherein the buffer memory has a predetermined memory capacity to save one or more sheets of image video signal.

7. The method for screen snapshot of claim 1, wherein the storage is a portable memory device.

8. The method for screen snapshot of claim 1, wherein the storage is a built-in memory device.

9. The method for screen snapshot of claim 1, wherein the storage is an external memory device.
